(19) United States
(12) Patent Application Publication
(10) Pub. No.: US 2023/0206549 A1
(43) Pub. Date: Jun. 29, 2023

(54) SYSTEM AND METHOD OF CREATING THREE-DIMENSIONAL VIRTUAL MODELS WITH A MOBILE DEVICE

(71) Applicant: Jordan Preston, Brooklyn, NY (US)

(72) Inventor: Jordan Preston, Brooklyn, NY (US)

(21) Appl. No.: 18/148,272

(22) Filed: Dec. 29, 2022

Related U.S. Application Data
(60) Provisional application No. 63/294,609, filed on Dec. 29, 2021.

(51) Int. Cl. G06T 17/00; H04N 23/698; G06T 15/04

(52) U.S. Cl. CPC G06T 17/00; H04N 23/698; G06T 15/04; G06T 2200/08; G06T 2210/56; H04N 23/64

(57) ABSTRACT

A method of creating a three-dimensional model of a physical space includes at a capturing device, scanning the physical space to acquire a three-dimensional scan of the physical space. Embodiments may also include acquiring a panoramic image of the physical space, where the panoramic image includes a complete panoramic image or first person view of the physical space. Embodiments may also include processing the three-dimensional scan of the physical space to generate a three-dimensional surface reconstruction of the physical space. Embodiments may also include mapping the complete panoramic image or first person view onto the three-dimensional surface reconstruction of the physical space to create the three-dimensional model of the physical space.

### CROSS-REFERENCE TO RELATED APPLICATIONS

This application claims the benefit of U.S. Provisional Application No. 63/294,609, filed on Dec. 29, 2021. The entire disclosure of the above application is incorporated herein by reference.

### FIELD

The present disclosure relates to three-dimensional models and designs and, more specifically, to the creation of three-dimensional virtual models using a mobile device.

### INTRODUCTION

The statements in this section merely provide background information related to the present disclosure and may not constitute prior art.

Three-dimensional modeling of property and spaces may provide benefits to developers, real estate, design, and construction professionals, sellers, owners, and buyers. A three-dimensional model may provide transparency by allowing a realistic visualization of a property or space, without having to be physically located within the space. An accurate three-dimensional model may be used to estimate design, remodel, and construction costs.

A three-dimensional model of a physical space is an immersive technology that permits a first-person visualization of the space. For a real estate professional, this may save time and money because a space may be virtually shown to a potential buyer. In fact, many online real estate listings primarily show properties through three-dimensional models. A three-dimensional model also lets a design or construction professional refine designs and ideas within the three-dimensional space. The three-dimensional model attempts to convey a realistic depiction in the virtual space. A seller may also reach a greater number of potential buyers with a three-dimensional model in contrast to a traditional in-person showing. Additionally, a three-dimensional model reduces the number of walk-throughs which reduces wear and tear to the space and other associated risks. For a buyer, the advantages of a three-dimensional model are numerous. A three-dimensional model allows the buyer to see each element of the space when making a purchasing decision. A designer or construction professional may try out design ideas and take measurements within the space.

While technology has transformed the ability to visualize a space through the creation of three-dimensional models, there are still some drawbacks. For example, creating a three-dimensional model may be expensive and time consuming. Additionally, it must be ensured that the entirety of the space has been modeled in an accurate matter so design and other costs may be properly calculated. If there are data gaps or other inconsistencies, then a proper view and dimensions of the space may not be conveyed. Moreover, creating the three-dimensional model is often done with specialized scanning equipment and other hardware, which must be purchased.

There is a continuing need for a system and method that may capture data to quickly create an accurate three-dimensional model of a space without using specialized scanning hardware.

### SUMMARY

In concordance with the instant disclosure, systems and methods that may capture data to quickly create an accurate three-dimensional model of a space without using specialized scanning hardware, have been surprisingly discovered.

The present technology may use a two-step process including a three-dimensional scan and a collection of images, such a collection of panoramic images, to create a refined three-dimensional model of a space. The three-dimensional scan may collect lidar depth data, and red, green, and blue, depth sensor data. In certain embodiments, the present technology may utilize a one-step process including the three-dimensional scan to collect lidar depth data, and red, green, and blue, depth sensor data, and panoramic data to create the refined three-dimensional model of a space.

The present technology is configured to create a three-dimensional virtual model. In certain embodiments, the virtual model may include a floor plan, a model orbit view, and an interior photographic view. The three-dimensional model allows a user to view the three-dimensional model, walk through a space, view a floorplan, and seamlessly transition between views. A viewer may measure the space based on the three-dimensional model, populate the space with labels, and create a narrative and a story of the space.

Embodiments of the present disclosure may include a method of creating a three-dimensional model of a physical space, including at a capturing device, scanning the physical space to acquire a three-dimensional scan of the physical space. Embodiments may also include acquiring an image of the physical space, where the image includes a panoramic image of the physical space. Embodiments may also include processing the three-dimensional scan of the physical space to generate a three-dimensional surface reconstruction of the physical space. The panoramic image may be mapped onto the three-dimensional surface reconstruction of the physical space to create the three-dimensional model of the physical space.

A pose of the capturing device may be determined based on a position and an orientation of the capturing device within the physical space before scanning the physical space. In some embodiments, the capturing device may be moved through the physical space to acquire the three-dimensional scan of the physical space. Embodiments may also include scanning the physical space using a lidar sensor, or other appropriately desired sensor, to collect lidar depth data, and red, green, and blue, depth sensor data.

The capturing device may include a hand-held device. In some embodiments, the capturing device may include one of a mobile device, a smartphone, a tablet, a digital camera, an action camera, a wearable computer, a smart watch, and a drone. Scanning the physical space to acquire a three-dimensional scan of the physical space and acquiring a panoramic image of the physical space may be done using an application of the capturing device.

The three-dimensional scan of the physical space may be processed to generate a three-dimensional surface reconstruction of the physical space that includes generating a three-dimensional point cloud and model. In certain embodiments, a color image may be mapped to a computed geometry of the space to produce a textured model. In some embodiments, the panoramic image may include a three-hundred-and-sixty-degree image of the physical space.

The panoramic image may be generated using more than one image. The panoramic image may be acquired using the capturing device. In some embodiments, the panoramic image may be continuously acquired until a full coverage panoramic image of the physical space is acquired. The panoramic image may be mapped onto the three-dimensional surface reconstruction by extracting a feature from a three-dimensional surface reconstruction color image and using the pose or known orientation of the capturing device to project the panoramic image onto the three-dimensional surface reconstruction. Embodiments may also include a processor of the capturing device rendering the three-dimensional surface reconstruction as a segment of the physical space is scanned.

In certain embodiments, the panoramic image may be mapped onto the three-dimensional surface reconstruction at the capturing device. Alternatively, the three-dimensional scan may be uploaded to a server to process the three-dimensional scan of the physical space to generate the three-dimensional surface reconstruction of the physical space. Embodiments may also include labeling an item within the three-dimensional model and taking a measurement.

In certain embodiments, a system may include a hardware processor configured by machine-readable instructions to at a capturing device, scan a physical space with the capturing device to obtain a three-dimensional scan of the physical space. Embodiments may also include collecting a panoramic image of the space using the capturing device. The three-dimensional scan of the physical space may be processed to generate a three-dimensional surface reconstruction of the physical space. Embodiments may also include mapping the panoramic image onto the three-dimensional surface reconstruction of the physical space to create a three-dimensional model of the physical space. In some embodiments, the capturing device includes a hand-held device. In some embodiments, the capturing device may include one of a mobile device, a smartphone, a tablet, a digital camera, an action camera, a wearable computer, a smart watch, and a drone.

The present technology may create an accurate three-dimensional virtual model of a space using a capturing device such as a mobile device or smartphone. A two-step process, which includes a three-dimensional scan and a panoramic image, may be used to create the refined three-dimensional model of the space. In particular, the present technology may utilize a two-step process. A scan where the user moves around to capture as much of the geometry of the space and a panorama where the user stays still to obtain the most accurate photo of the space.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 is a flowchart illustrating a method of creating a three-dimensional model of a physical space, according to an embodiment of the present disclosure.

FIG. 2 is a flowchart illustrating a method of creating a three-dimensional model, according to another embodiment of the present disclosure.

FIG. 3 is a flowchart illustrating a user interface for a method of creating a three-dimensional model, according to an embodiment of the present disclosure.

FIG. 4 is schematic of a system for creating a three-dimensional model with a capturing device, according to an embodiment of the present disclosure.

### DETAILED DESCRIPTION

The following description of technology is merely exemplary in nature of the subject matter, manufacture and use of one or more inventions, and is not intended to limit the scope, application, or uses of any specific invention claimed in this application or in such other applications as may be filed claiming priority to this application, or patents issuing therefrom. Regarding methods disclosed, the order of the steps presented is exemplary in nature, and thus, the order of the steps may be different in various embodiments, including where certain steps may be simultaneously performed, unless expressly stated otherwise. “A” and “an” as used herein indicate “at least one” of the item is present; a plurality of such items may be present, when possible. Except where otherwise expressly indicated, all numerical quantities in this description are to be understood as modified by the word “about” and all geometric and spatial descriptors are to be understood as modified by the word “substantially” in describing the broadest scope of the technology. “About” when applied to numerical values indicates that the calculation or the measurement allows some slight imprecision in the value (with some approach to exactness in the value; approximately or reasonably close to the value; nearly). If, for some reason, the imprecision provided by “about” and/or “substantially” is not otherwise understood in the art with this ordinary meaning, then “about” and/or “substantially” as used herein indicates at least variations that may arise from ordinary methods of measuring or using such parameters.

Although the open-ended term “comprising,” as a synonym of non-restrictive terms such as including, containing, or having, is used herein to describe and claim embodiments of the present technology, embodiments may alternatively be described using more limiting terms such as “consisting of” or “consisting essentially of” Thus, for any given embodiment reciting materials, components, or process steps, the present technology also specifically includes embodiments consisting of, or consisting essentially of, such materials, components, or process steps excluding additional materials, components or processes (for consisting of) and excluding additional materials, components or processes affecting the significant properties of the embodiment (for consisting essentially of), even though such additional materials, components or processes are not explicitly recited in this application. For example, recitation of a composition or process reciting elements A, B and C specifically envisions embodiments consisting of, and consisting essentially of, A, B and C, excluding an element D that may be recited in the art, even though element D is not explicitly described as being excluded herein.

As referred to herein, disclosures of ranges are, unless specified otherwise, inclusive of endpoints and include all distinct values and further divided ranges within the entire range. Thus, for example, a range of “from A to B” or “from about A to about B” is inclusive of A and of B. Disclosure of values and ranges of values for specific parameters (such as amounts, weight percentages, etc.) are not exclusive of other values and ranges of values useful herein. It is envisioned that two or more specific exemplified values for a given parameter may define endpoints for a range of values that may be claimed for the parameter. For example, if Parameter X is exemplified herein to have value A and also exemplified to have value Z, it is envisioned that Parameter X may have a range of values from about A to about Z. Similarly, it is envisioned that disclosure of two or more ranges of values for a parameter (whether such ranges are nested, overlapping or distinct) subsume all possible combination of ranges for the value that might be claimed using endpoints of the disclosed ranges. For example, if Parameter X is exemplified herein to have values in the range of 1-10, or 2-9, or 3-8, it is also envisioned that Parameter X may have other ranges of values including 1-9, 1-8, 1-3, 1-2, 2-10, 2-8, 2-3, 3-10, 3-9, and so on.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” may encompass both an orientation of above and below. The device may be otherwise oriented (rotated 90 degrees or at other orientations) and the spatially relative descriptors used herein interpreted accordingly.

In certain embodiments, the present technology includes a system and method of creating a three-dimensional model using a capturing device, such as a mobile device, as a non-limiting example. The system may include a mobile application. The mobile application may prompt a user to capture a space in which a three-dimensional model is desired. The capture may involve scanning the space with the capturing device and obtaining panoramic images. The application may then perform backend processing of the captured data to create a three-dimensional reconstruction. The processing may include creation of a point cloud, creation of a surface, optimization of the surface, and application of textures to the surface. The application may then refine the three-dimensional model and insert the panoramic images within the model.

In some embodiments, inserting the panoramic images includes matching the location of the panoramic images to the surfaces of the three-dimensional model. This may match the panoramic images to a location within the physical space. For example, a position and an orientation of a panoramic image may be determined within the three-dimensional model by extracting a feature from color images of a scan of the space. The panoramic image may be mapped to the three-dimensional model using a known pose and depth to project the features of the panoramic image into the three-dimensional space. This may help create a seamless model experience. Particularly, the geometry of the three-dimensional model may also aid in visualization and seamless transitioning between panoramic images in a photographic view.

In certain embodiments, the system includes a two-step process including a three-dimensional scan followed by a collection of panoramic images. Alternatively, the system may include a one-step process, where the three-dimensional scan data is used to create the three-dimensional model.

In certain embodiments, an application may be configured to provide visual feedback to the user during the scan. The feedback may indicate to a user which portions of the physical space have been scanned. The visual feedback may include the application of color to the scanned portions when viewed through a capturing device, or the visual feedback may include a blurred visual effect that is removed as the space is scanned. In certain embodiments, the visual feedback may include a textured surface and/or a realistic surface to represent the physical space. Particularly, the visual feedback may include any appropriately desired surface or other aspect to represent the physical space.

In another aspect, a method of creating a three-dimensional model with a capturing device may include, at the capturing device, prompting a user to capture a three-dimensional model of a space, scanning the space with the capturing device to obtain a three-dimensional scan of the space, collecting a panoramic image of the space using the capturing device, processing the three-dimensional scan of the space to generate a three-dimensional surface reconstruction of the space, and mapping the panoramic image onto the three-dimensional surface reconstruction of the space to create the three-dimensional model. In certain embodiments, a processor of the capturing device begins to render the three-dimensional surface reconstruction immediately as a segment of the space is scanned. In some embodiments, mapping the panoramic image onto the three-dimensional surface reconstruction is at the capturing device. Alternatively, the three-dimensional surface reconstruction may be processed at a remotely located server or cloud device. In some embodiments, the capturing device comprises one of a mobile device, a smartphone, a tablet, a digital camera, an action camera, a wearable computer, a smart watch, and a drone. However, the capturing device may comprise any appropriately desired capturing device for capturing a three-dimensional and a panoramic image. In certain embodiments, the capturing device may include a three-hundred-and-sixty-degree camera.

Certain embodiments of the present technology may include the following aspects. A three-dimensional virtual model of a space can be created using a capturing device and an application located on the capturing device. The capturing device may be used to scan a space, take images of the space, label and annotate features, and share the created space. In an example, a capture step may comprise completing a three-dimensional scan of the space and taking a panoramic image. In some embodiments, the items or features within the space may be labeled. The method may include backend processing of the captured data. In some embodiments, this may include a three-dimensional construction including creating a point cloud, creating a surface, optimizing the surface, and texturing the surface. The three-dimensional scan may be refined, and a panoramic image may be mapped onto the scan to create the three-dimensional model. In certain embodiments, an identifier may be placed within the three-dimensional model to indicate a direction of entry and/or flow of the three-dimensional virtual model. In some embodiments, the three-dimensional space may be staged with objects and measured.

In certain embodiments, it may be desirable to add another space. In these embodiments, the present technology may end scanning and taking images for a first space. A user may then begin to scan an additional space. To relocalize, the method may guide a user to a previously scanned area which will enable the capturing device to regain tracking of a position within the space by initializing a previously established coordinate system. When relocalization is completed, a user may be prompted to scan while walking to the new space so that the new space is connected to a three-dimensional map in which the originally scanned space is located.

After a three-dimensional space is created, in certain embodiments, the three-dimensional virtual model may be uploaded to and otherwise accessible from a cloud or other webserver. In certain embodiments, a uniform resource locator (URL) may be shared to the creator of the three-dimensional model so that the three-dimensional model is viewable. In certain embodiments, the creator of the model may annotate and/or label items with the three-dimensional model. A creator may also share the URL with a viewer, such as a client or other interested viewer.

Creating a three-dimensional virtual model of a space using a capturing device and an application located on the capturing device may also include creating an internal positioning system. The internal positioning system may include a three-dimensional planar coordinate system to identify a position and an orientation of the capturing device within a physical space. The position and orientation of the capturing device may establish the starting point of the three-dimensional scan within the physical space. The internal positioning system and a sensor of the capturing device, such as a gyroscope, lidar sensor, or other appropriately desired sensor of the capturing device, may determine a pose of the capturing device, which may include a direction of the sensors of the capturing device and a location of the capturing device. The capturing device may use a lidar sensor or other appropriately desired sensor to obtain a depth reading and store the position and orientation of the depth reading.

The method and system may further use localization, where previous data is considered, and a panoramic image may be matched to a geometry of the surface scan to indicate where the capturing device has moved, and a new position and orientation of the capturing device is estimated. The new depth location may be used as coordinates to draw vectors connecting points of the three-dimensional model, which result in a surface, including a collection of vectors that connect the coordinates of the depth points.

In certain embodiments, the capturing device may use a red, green, blue, depth camera to acquire an image. The pose location may be stored with the red, green, blue depth data. Additional panoramic images with pose data may be acquired, refined and the images mapped onto a surface of a three-dimensional surface reconstruction of the physical space to create a three-dimensional model of the physical space. In certain embodiments, the accuracy of the surface may be improved by confirming a predicted scan data point.

In certain embodiments, the method may provide visual feedback to a user during the three-dimensional scan of the physical space. For example, when the user scans the physical space, it may be difficult to determine whether a location within the physical space has been scanned. Real-time feedback may illustrate those areas that have been scanned. In certain embodiments, the real time feedback may be provided through the capture device. The real-time feedback may be visual to indicate to the user which portions of the space have been scanned. The visual feedback may include an application of color to the scanned sections of the physical space when viewed through the capturing and/or mobile device. Alternatively, the visual feedback may include a blurred visual effect that is removed as the space is scanned. Alternatively, the visual feedback may include a smaller map which may be a three-dimensional model or birds eye view of an actual physical geometry of the space which has been scanned. In certain embodiments, the visual feedback may include an icon such as a triangle, with a north and south to guide a user to take an image within the physical space.

A user may point the capture device at a location and visualize the space through a lens of the capture device. The user may be instructed to move the capture device to begin a scan of the space. As the user scans the space, the user may see a surface in the space become highlighted in a color (e.g., green). The highlighted and/or colored surface may indicate that the area has been scanned. Surfaces not highlighted in color (e.g., green) have not been scanned. The user may move around the space while scanning until all desired surfaces are highlighted in color (e.g., green) and are therefore indicated as scanned. Once the desired surfaces in the space have been scanned, a user is able to view a three-dimensional model composed of a colored surface.

In certain embodiments, an overlay may include a photographic three-dimensional textured visualization of objects and walls within the physical space. For example, areas which are not recreated in the three-dimensional space may not show up as bright. Therefore, the user can identify that these areas need to be captured. A three-dimensional representation of the space may be shown in real time so that a user knows when the entire space has been captured.

In certain embodiments, a user may point the capture device at a location and see the space through a lens of the capture device. The user may be instructed to move the capture device to begin a scan of the space. As the user begins a scan, the space to be captured may be slightly blurred. As the user scans the space, surfaces that have been scanned may be changed from blurred to clear and may be shown as reconstructed photographic textured objects in a higher quality unblurred texture.

In certain embodiments, when standing from a singular location, such as when using a tripod, a user may rotate the capture device around a singular point to obtain a series of component photographs to create a panoramic image. A user may commence obtaining a panoramic image by clicking start on an application and will then see a triangular reticle and be instructed to hit the targets by rotating the reticle clockwise to align the reticle to subsequent targets. Upon successfully rotating the device and reticle (which stays stationary on the device screen) to hit the target the original target will illuminate to show a successful hit and then disappear and show another new target for which the user will continue to rotate until the next target is hit.

Aspects of the present technology further relate to creating an accurate three-dimensional model, such as a three-dimensional virtual model of a space using a capturing device such as a smartphone or other mobile device. The present technology may use a two-step process including a three-dimensional scan followed by a collection of panoramic images to create a refined three-dimensional model of a space. Advantageously, the present technology uses the two-step process, which combines the accurate three-dimensional model and overlays a panoramic image to create a realistic walkthrough experience. By mapping a panoramic image to the three-dimensional model, the present technology may create a seamless viewing experience with enhanced transitions, so a user may accurately navigate the three-dimensional space. Specifically, the present technology creates a walkthrough experience from a viewer's perspective, such as a first-person walkthrough experience. The panoramic images create a first-person walkthrough experience such that there is a seamless viewing experience throughout the three-dimensional space.

The three-dimensional model creation of the present technology may also utilize an optimized tiling methodology to enable quick viewing of the three-dimensional model. An algorithm may serve, decompress, and prioritize parts of the images of the panoramas in the three-dimensional model. The present technology may create large virtual models by creating large three-dimensional models with an advanced textured mesh, where a user may add additional rooms and floors through relocalization. The three-dimensional model may also enable virtual staging and/or integration of furniture and other objects to fill the three-dimensional space. In certain embodiments, the three-dimensional model is an accurate reconstruction of a space that may be measured for construction, remodeling, and other projects. In this manner, the present technology may enable a user to accurately visualize a space to take accurate measurements and/or stage the physical space. The three-dimensional model of the present technology may be more accurate because more surface area may be scanned as a user moves through a physical space to acquire the scan rather than acquiring the images and/or the scan from a fixed space. For example, the user may move about the physical space to view an entirety of the perimeter of the physical space to acquire a three-dimensional scan of the space. A user may move the capturing device through an S-shaped corridor or an L-shaped room such that an entire perimeter of the space is acquired during the three-dimensional scan of the space. In particular, the capturing device may be physically moved from a fixed location such that an accurate three-dimensional scan of the space may be acquired.

In addition, the panoramic images may be placed in a logical viewing order, so the user may accurately and efficiently move about the space. As such, the present technology as described herein has many advantages.

### EXAMPLES

Example embodiments of the present technology are provided with reference to the several figures enclosed herewith.

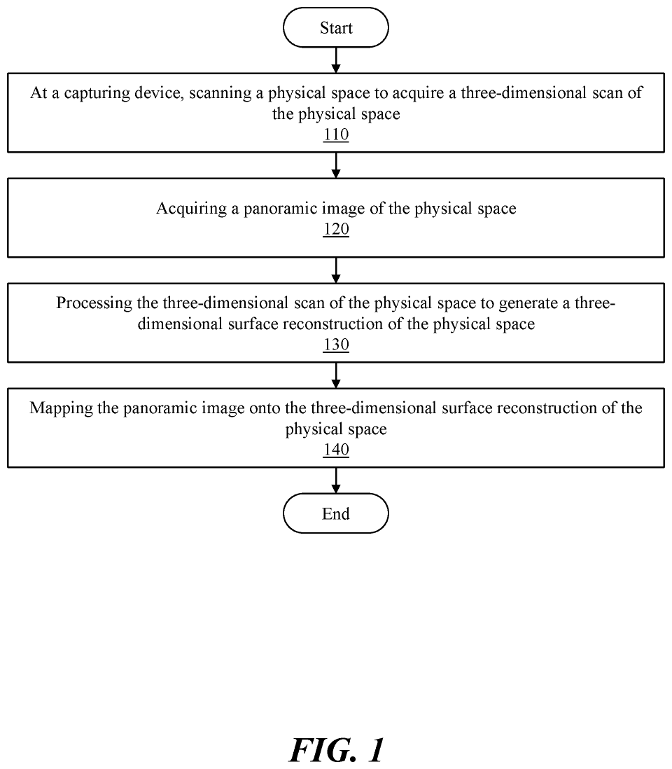

FIG. 1 is a flowchart that describes a method of creating a three-dimensional model of a physical space, according to some embodiments of the present disclosure. In some embodiments, at 110, the method may include, at a capturing device, scanning a physical space to acquire a three-dimensional scan of the physical space. At 120, the method may include acquiring a panoramic image of the physical space. At 130, the method may include processing the three-dimensional scan of the physical space to generate a three-dimensional surface reconstruction of the physical space. At 140, the method may include mapping the panoramic image onto the three-dimensional surface reconstruction of the physical space to create the three-dimensional model of the physical space.

In some embodiments, a pose of the capturing device may be determined based on a position and an orientation of the capturing device within the physical space before scanning the physical space. In some embodiments, the capturing device may be moved through the physical space to acquire the three-dimensional scan of the physical space. In some embodiments, scanning the physical space may include collecting lidar depth and red, green, and blue depth data.

The capturing device may include a hand-held device. In some embodiments, the capturing device may include one of a mobile device, a smartphone, a tablet, a digital camera, an action camera, a wearable computer, a smart watch, and a drone. Scanning the physical space to acquire a three-dimensional scan of the physical space and acquiring a panoramic image of the physical space, may be done using an application of the capturing device.

Processing the three-dimensional scan of the physical space to generate a three-dimensional surface reconstruction of the physical space may include generating a three-dimensional point cloud and model. A color image may be mapped to a computed geometry to produce a textured model. The panoramic image may include a three-hundred-and-sixty-degree panoramic image of the physical space.

In some embodiments, the panoramic image may be generated using multiple images. The panoramic image may be acquired using the capturing device. In particular, the panoramic image may be continuously acquired until a full coverage of the physical space is acquired. The panoramic image may be mapped onto the three-dimensional surface reconstruction by extracting a feature from a three-dimensional surface reconstruction color image and using the pose of the capturing device to project the panoramic image onto the three-dimensional surface reconstruction.

In particular, the three-dimensional model of the physical space may include a virtual reality model of the physical space. Panoramic images of the physical space may be used to generate a first person view of the physical space. A three-dimensional scan of the physical space may be processed to generate a three-dimensional surface reconstruction of the physical space. The first person view may be mapped onto the three-dimensional surface reconstruction of the physical space to create the three-dimensional virtual reality model of the space. A complete panoramic image of the physical space may include a first person view of the physical space.

In certain embodiments, the three-dimensional virtual model may be a realistic view of a space, which may be achieved by combining an image and a geometry of the space to generate transitions and perspective views to replicate a way a human may interpret the space. Three-dimensional scan may be composed of a three-dimensional geometry, red, green, and blue depth images, and a textured mesh. The three-dimensional scans and panoramic images may be used together to generate the three-dimensional surface reconstruction.

A processor of the capturing device may begin to render the three-dimensional surface reconstruction as a segment of the physical space is scanned. In some embodiments, mapping the panoramic image onto the three-dimensional surface reconstruction may be at the capturing device. Alternatively, the three-dimensional scan may be uploaded to a server to process the three-dimensional scan of the physical space to generate the three-dimensional surface reconstruction of the physical space. In some embodiments, an item of the three-dimensional model may be labeled.

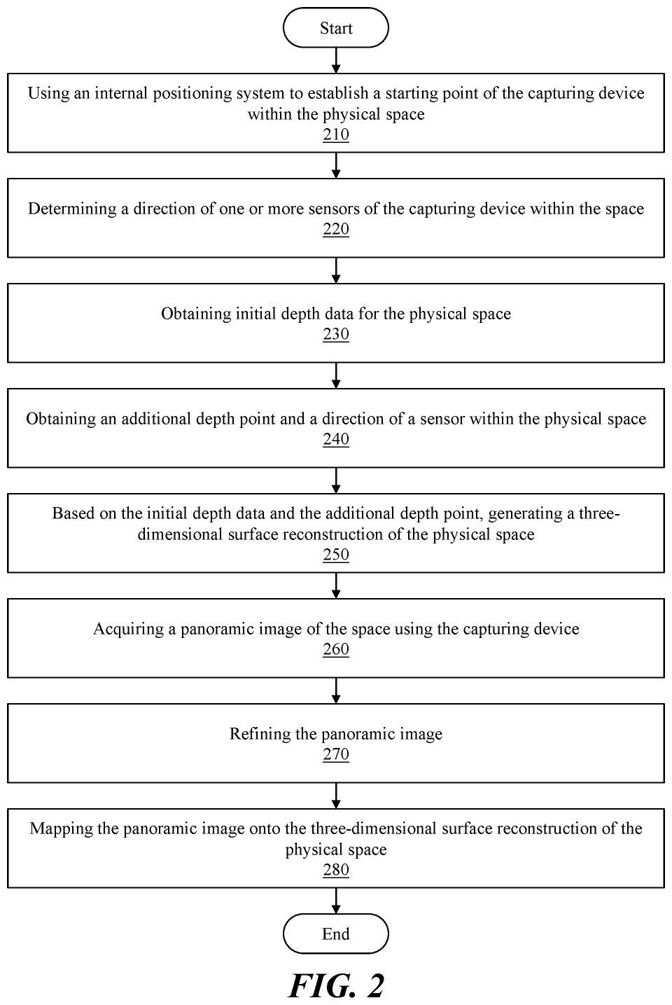

FIG. 2 is a flowchart that describes a method of creating a three-dimensional model, according to some embodiments of the present disclosure. In some embodiments, at 210, the method may include using an internal positioning system to establish a starting point of the capturing device within the physical space. At 220, the method may include determining a direction of a sensor of the capturing device within the space. At 230, the method may include obtaining initial depth data for the physical space. At 240, the method may include obtaining an additional depth point and a direction of the sensor within the physical space. At 250, the method may include, based on the initial depth data and the depth point, generating a three-dimensional surface reconstruction of the physical space. At 260, the method may include acquiring a panoramic image of the space using the capturing device. At 270, the method may include refining the panoramic image. At 280, the method may include mapping the panoramic image onto the three-dimensional surface reconstruction of the physical space to create the three-dimensional model.

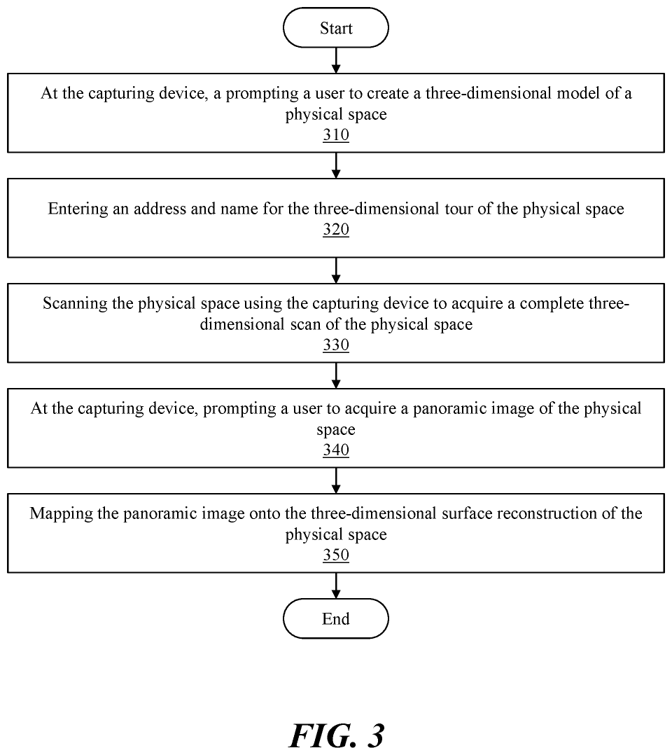

FIG. 3 is a flowchart that describes a user interface of a method of creating a three-dimensional model, according to some embodiments of the present disclosure. In some embodiments, at 310, the method may include, at the capturing device, prompting a user to create a three-dimensional model of a physical space. At 320, the method may include entering an address and a name for the three-dimensional model of the physical space. At 330, the method may include scanning the physical space using the capturing device to acquire a complete three-dimensional scan of the physical space. At 340, the method may include, at the capturing device, prompting a user to acquire a panoramic image of the physical space. At 350, the method may include mapping the panoramic image onto the three-dimensional surface reconstruction of the physical space to create the three-dimensional model of the physical space. The panoramic image may be generated using a plurality of panoramic images.

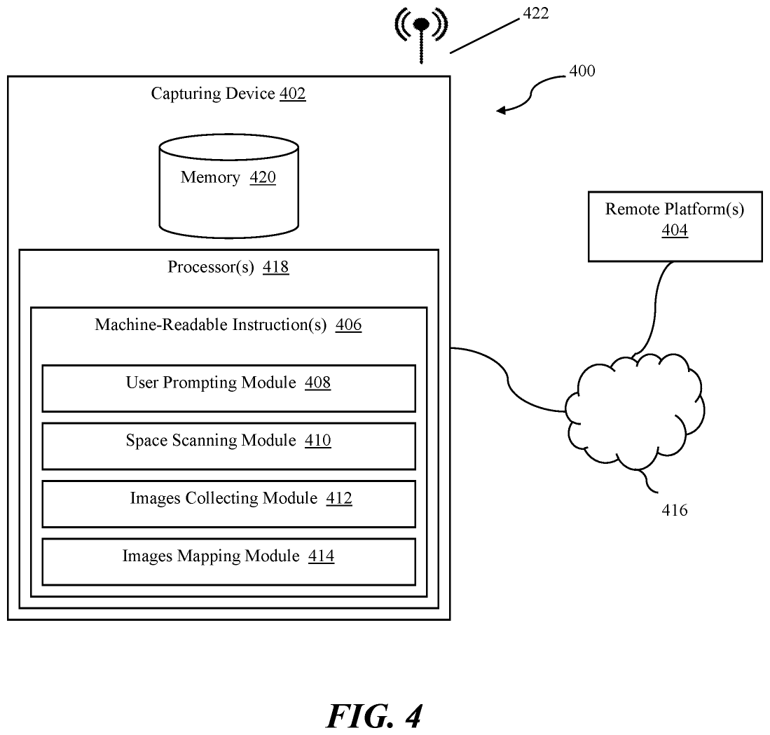

FIG. 4 shows a schematic of a system 400 configured for creating a three-dimensional model with a capturing device 402, in accordance with certain embodiments. In certain embodiments, the system 400 may include a capturing device 402 that may be configured by machine-readable instructions 406 stored on a non-transient computer readable medium. Machine-readable instructions 406 may include various modules. The modules may be implemented as functional logic, hardware logic, electronic circuitry, software modules, and the like. The modules may include a user prompting module 408, a space scanning module 410, an images collecting module 412, an images mapping module 414, and/or other modules as appropriately desired. The images collecting module 412 can collect panoramic images, for example. The capturing device 402 may be communicably coupled with a remote platform 404. In certain embodiments, users may access the system 400 via remote platform(s) 404. As described above, in some embodiments, the system 400 may be configured to upload a finished model to the remote platform 404.

The system 400 may comprise any appropriate number and configuration of modules for creating a three-dimensional model as desired. For example, in some embodiments, the system comprises a lidar module to obtain a depth reading. Alternatively, or in conjunction, the system 400 comprises a gyroscope module for sensing a direction of a sensor of the capturing device 402. Particularly, the system 400 may comprise any appropriate number and configuration of inertial measuring units (IMUs), micro-electro-mechanical (MEMs), lidar sensors, modules, and other sensors.

The user prompting module 408 and other modules may be a component of an application stored in a memory of the capturing device 402. The user prompting module 408 may be configured to at the capturing device 402, to prompt a user to capture a three-dimensional model of a space. The space scanning module 410 may be configured to scan the space with the capturing device 402 to obtain a three-dimensional scan of the space. The images collecting module 412 may be configured to collect one or more panoramic images of the space using the capturing device 402. In some embodiments, the space scanning module 410 and the images collecting module 412 may include a camera of the capturing device 402.

In some embodiments, the processor 418 may be configured to process the three-dimensional scan of the space to generate a three-dimensional surface reconstruction of the space. The images mapping module 414 may map a panoramic image onto the three-dimensional surface reconstruction of the space to create the three-dimensional model. In some embodiments, the processor 418 of the capturing device begins to render the three-dimensional surface reconstruction immediately as a segment of the space is scanned and mapping of the panoramic image onto the three-dimensional surface reconstruction may be at the capturing device. Alternatively, the three-dimensional model may be created at a remotely located server. In certain embodiments, the capturing device 402 includes one of a mobile device, a smart phone, a tablet, a digital camera, an action camera, a wearable computer, a smart watch, and a drone.

In certain embodiments, the capturing device 402, is communicatively coupled to the remote platform(s) 404. In certain embodiments, the communicative coupling may include communicative coupling through a networked environment 416. The networked environment 416 may be a radio access network, such as LTE or 5G, a local area network (LAN), a wide area network (WAN) such as the Internet, or wireless LAN (WLAN), for example. It will be appreciated that this is not intended to be limiting, and that the scope of this disclosure includes implementations in which the capturing device 402 and the remote platform 404 may be operatively linked via some other communication coupling. In some embodiments, the capturing device 402 is configured to communicate with the networked environment 416 via wireless or wired connections.

In an embodiment, the system 400 may also include a host or server, such as the remote platform 404 connected to the networked environment 416 through wireless or wired connections. According to one embodiment, remote platforms 404 may be implemented in or function as base stations (which may also be referred to as Node Bs or evolved Node Bs (eNBs)). In other embodiments, remote platforms 404 may include web servers, mail servers, application servers, etc. According to certain embodiments, the remote platform 404 may be a standalone server, a networked server, and an array of servers.

The capturing device 402 may include a processor 418 for processing information and executing instructions or operations. The processor 418 may be any type of general or specific purpose processor. In certain embodiments, multiple processors 418 may be utilized according to other embodiments. In fact, the processor 418 may include a general-purpose computer, a special purpose computer, microprocessors, digital signal processors (DSPs), field-programmable gate arrays (FPGAs), application-specific integrated circuits (ASICs), and a processor based on a multi-core processor architecture, as examples. In certain embodiments, the processor 418 may be remote from the capturing device 402, such as disposed within a remote platform 404 like the remote platform 404 of FIG. 4.

The processor 418 may perform functions associated with the operation of system 400 which may include, for example, precoding of antenna gain/phase parameters, encoding and decoding of individual bits forming a communication message, formatting of information, and overall control of the capturing device 402, including processes related to management of communication resources.

The capturing device 402 may further include or be coupled to a memory 420 (internal or external), which may be coupled to the processor 418, for storing information and instructions that may be executed by the processor 418. In some embodiments, an application for creating the three-dimensional model, such as described above is stored within the memory 420. Memory 420 may be any type suitable to the local application environment and may be implemented using any suitable volatile or nonvolatile data storage technology such as a semiconductor-based memory device, a magnetic memory device and system, an optical memory device and system, fixed memory, and removable memory. For example, memory 420 may consist of any combination of random access memory (RAM), read only memory (ROM), static storage such as a magnetic or optical disk, hard disk drive (HDD), or any other type of non-transitory machine or computer readable media. The instructions stored in memory 420 may include program instructions or computer program code that, when executed by the processor 418, enable the capturing device 402 to perform tasks as described herein.

In some embodiments, the capturing device 402 may include or be coupled to an antenna 422 for transmitting and receiving signals and/or data to and from the capturing device 402. The antenna 422 may be configured to communicate via, for example, a plurality of radio interfaces that may be coupled to the antenna 422. The radio interfaces may correspond to a plurality of radio access technologies including LTE, 5G, WLAN, Bluetooth, near field communication (NFC), radio frequency identifier (RFID), ultrawideband (UWB), and the like. The radio interface may include components, such as filters, converters (for example, digital-to-analog converters and the like), mappers, a Fast Fourier Transform (FFT) module, and the like, to generate symbols for a transmission via a downlink and to receive symbols (for example, via an uplink).

As described above, in certain embodiments, the technology as described herein may be communicatively coupled to the remote platform 404. In certain embodiments, the communicative coupling may include communicative coupling through a networked environment. The networked environment may be a radio access network, such as LTE or 5G, a local area network (LAN), a wide area network (WAN) such as the Internet, or wireless LAN (WLAN), for example. It will be appreciated that this is not intended to be limiting, and that the scope of this disclosure includes implementations in which a computing platform and a remote platform 404 may be operatively linked via some other communication coupling. The capturing device may be configured to communicate with the networked environment via wireless or wired connections.

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms, and that neither should be construed to limit the scope of the disclosure. In some example embodiments, well-known processes, well-known device structures, and well-known technologies are not described in detail. Equivalent changes, modifications and variations of some embodiments, materials, compositions, and methods may be made within the scope of the present technology, with substantially similar results.

What is claimed is:

1. A method of creating a three-dimensional virtual reality model of a physical space, comprising:
at a capturing device, scanning the physical space to acquire a three-dimensional scan of the physical space;
acquiring panoramic images of the physical space, where the panoramic images are used to generate a complete panoramic image of the physical space;
processing the three-dimensional scan of the physical space to generate a three-dimensional surface reconstruction of the physical space; and
mapping the complete panoramic image onto the three-dimensional surface reconstruction of the physical space to create the three-dimensional virtual reality model of the physical space.

2. The method of claim 1, wherein a pose of the capturing device is determined based on a position and an orientation of the capturing device within the physical space before scanning the physical space.

3. The method of claim 1, wherein the capturing device is moved through the physical space to acquire the three-dimensional scan of the physical space.

4. The method of claim 1, wherein scanning the physical space includes collecting lidar depth and red, green, and blue depth data.

5. The method of claim 1, wherein the capturing device includes a hand-held device.

6. The method of claim 5, wherein the capturing device comprises one of a mobile device, a smartphone, a tablet, a digital camera, an action camera, a wearable computer, a smart watch, and a drone.

7. The method of claim 6, wherein scanning the physical space to acquire the three-dimensional scan of the physical space and acquiring the complete panoramic image view of the physical space, is performed using an application of the capturing device.

8. The method of claim 1, wherein processing the three-dimensional scan of the physical space to generate the three-dimensional surface reconstruction of the physical space includes generating a three-dimensional point cloud and model, wherein a color image is mapped to a computed geometry to produce a textured model.

9. The method of claim 1, wherein the panoramic image is acquired using the capturing device.

10. The method of claim 9, wherein the panoramic image includes a three-hundred-and-sixty-degree image of the physical space.

11. The method of claim 10, wherein the panoramic image is continuously acquired to generate the complete panoramic image of the physical space.

12. The method of claim 11, wherein the complete panoramic image view is generated using a plurality of panoramic images.

13. The method of claim 12, wherein the complete panoramic image is mapped onto the three-dimensional surface reconstruction by matching a feature from the panoramic image to or from a three-dimensional surface reconstruction color image and using a pose of the capturing device to project the complete panoramic image onto the three-dimensional surface reconstruction.

14. The method of claim 12, wherein visual feedback at the capturing device guides a user acquire the panoramic images of the physical space.

15. The method of claim 1, wherein mapping the complete panoramic image onto the three-dimensional surface reconstruction is at the capturing device.

16. The method of claim 1, wherein the three-dimensional scan is uploaded to a server to process the three-dimensional scan of the physical space to generate the three-dimensional surface reconstruction of the physical space.

17. The method of claim 1, further comprising labeling an item of the three-dimensional virtual reality model.

18. A system for creating a three-dimensional model of a physical space, comprising:
one or more hardware processors configured by machine-readable instructions to:
at a capturing device, scan a physical space with the capturing device to obtain a three-dimensional scan of the physical space;
collect a panoramic image of the physical space using the capturing device where the panoramic image includes a complete panoramic image of the physical space;
process the three-dimensional scan of the physical space to generate a three-dimensional surface reconstruction of the physical space; and
map the panoramic image onto the three-dimensional surface reconstruction of the physical space to create a three-dimensional model of the physical space.

19. The system of claim 18, wherein the capturing device includes a hand-held device.

20. The system of claim 19, wherein the capturing device comprises one of a mobile device, a smartphone, a tablet, a digital camera, an action camera, a wearable computer, a smart watch, and a drone.
